(19) United States
(12) Patent Application Publication
(10) Pub. No.: US 2008/0195532 A1
(43) Pub. Date: Aug. 14, 2008

(54) SYSTEMS AND METHODS FOR PROCESSING DONATIONS

(75) Inventors: Gordon S. Harkins, Clinton, MS (US); Robert Price Johnson, Union, MS (US); David Wyatt Russell, Madison, MS (US)

Correspondence Address: KNOBBE MARTENS OLSON & BEAR LLP, 2040 MAIN STREET, FOURTEENTH FLOOR, IRVINE, CA, 92614, US

(73) Assignee: IP Holdings & Acquisitions, LLC, Madison, MS (US)

(21) Appl. No.: 11/674,070

(22) Filed: Feb. 12, 2007

(51) Int. Cl. G06Q 40/00

(52) U.S. Cl. 705/39

(57) ABSTRACT

In one embodiment, a donation computing device is configured to receive donations from donors and to allot to the donor a quantity of donation indications that may be included in electronic communications transmitted by the donor. The allotted number of donation indications may be based at least partly on a donation amount received from the donor and/or a denomination amount associated with the donation indications. The donation indications may comprise graphical images and/or text, for example, such as representations of postage stamps that may be inserted into emails. The recipients of the electronic communications may then make additional donations to the donee in response to viewing the donation indication in the received electronic communication. In one embodiment, the donees may access information about the donors, such as contact information, so that the donees may transmit thank you communications to the donors and encourage that further donations are made.

### CROSS-REFERENCED APPLICATIONS

This application was filed on the same day as the following application entitled “Systems and Methods for Providing Electronic Donation Indication,” Ser. No. ______ [RJVEN.001A] all of which is hereby incorporated by reference in its entirety herein.

### LIMITED COPYRIGHT AUTHORIZATION

A portion of the disclosure of this patent document includes material which is subject to copyright protection. The copyright owner has no objection to the facsimile reproduction by anyone of the patent document or the patent disclosure as it appears in the Patent and Trademark Office patent file or records, but otherwise reserves all copyrights whatsoever.

### BACKGROUND OF THE INVENTION

1. Field of the Invention

This invention relates generally to donations, and more specifically, to systems and methods for allotting donation indications to donors and tracking use of the allotted donation indications.

2. Description of the Related Art

An increased amount of electronic communications has enabled a wide variety of the public to communicate with other members of the public. In addition, there are numerous types of electronic communication channels that are now available.

Among the members of the public are organizations that are looking for donors. In the past, such organizations have sent communications via postal mail and have created their own websites that allow potential donors to visit their websites and make direct donations to the organization. However, such systems do not utilize the wide variety of electronic communication channels that are now available.

Thus, there is a need for improving the manner in which organizations communicate with potential donors.

### SUMMARY OF THE INVENTION

The systems, method, and devices of the present invention each have several aspects, no single one of which is solely responsible for its desirable attributes. Without limiting the scope of this invention as expressed by the claims which follow, its more prominent features will now be discussed briefly.

In one embodiment, a computerized system comprises a donation computing device and a donor computing device in communication via one or more networks. In one embodiment, the computerized system comprises a donee management module configured to receive information regarding one or more donees and maintain donation information regarding the one or more donees; an account management module configured to receive information from the donor computing device regarding a donation amount to be made to a selected one of the donees, the donation amount being associated with an allotted number of donation indications; and an interface module configured to provide a software application to the donor computing device, the software application being configured to allow an electronic communication application on the donor computing device to include one or more of the donation indications in selected electronic communications sent from the electronic communication application, the software application being further configured to track a quantity of donation indications included in electronic communications transmitted from the donor computing device.

In another embodiment, a computerized method of transferring a donation to a donee comprises receiving a payment for an allotted number of donation indications; transmitting at least a portion of the payment to a donee; providing software code for integration with an electronic communication client installed on a donor computing device, the software code being configured to allow the donor to include one or more donation indications in an electronic communication sent from the donor computing device, the software code being further configured to track a number of donation indications that are included in electronic communications sent from the donor computing device; and periodically receiving from the software code installed on the donor computing device a status indicator indicating a number of donation indications that were included in electronic communications sent from the donor computing device since the last periodic status indicator was received.

In another embodiment, a software add-in is stored on a computer readable medium and configured for transmission to a computing device for installation on the computing device. In one embodiment, the add-in being configured for interaction with communication software installed on the computing device. In one embodiment, the add-in comprises a tracking module configured to allow the communication software to include at least one indication of a donation made by a user of the computing device in an electronic communication sent from the computing device, the tracking module being further configured to track a quantity of the donation indications that are included in electronic communications sent by the user.

In another embodiment, an electronic device for communication with a user comprises a computing platform including a graphical user interface; a processor; and a computer storage medium including a set of software instructions. In one embodiment, the set of software instructions comprises displaying an interface that assists a user to determine a donation amount that is associated with a quantity of electronic communications sent in a time frame; receiving an indication of a quantity of electronic communications the user anticipates sending in the time frame; receiving an indication of a donation amount; calculating a number of time frames the donation amount will last using a first denomination amount for the donation indications; and displaying in the interface the number of time frames the donation amount will last using a first denomination amount for the donation indications.

In another embodiment, a computerized system for transferring a donation from a donor to a donee comprises an input module for receiving respective donations from one or more donors; a donee management module configured to determine when a donation payment should be sent to the donee; and a verification module configured to generate a verification code associated with the donation payment, the verification code being usable by the donee to access information regarding the one or more donors.

In another embodiment, a method of transferring a donation amount to a donee comprises receiving a donation amount from one or more donors for a donee; determining a donation balance due to the donee since a last donation payment was made to the donee; determining, based at least partly on the donation balance, when a donation payment should be sent to the donee; and generating a verification code associated with the donation payment, the verification code being usable by the donee to access information regarding the one or more donors.

In another embodiment, a storage medium includes a computer program stored thereon for performing the method of receiving a donation amount from one or more donors for a donee; determining a donation balance due to the donee since a last donation payment was made to the donee; determining, based at least partly on the donation balance, when a donation payment should be sent to the donee; and generating a verification code associated with the donation payment, the verification code being usable by the donee to access information regarding the one or more donors.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### BRIEF DESCRIPTION OF THE DRAWINGS

FIG. 1 is a block diagram illustrating one embodiment of a computing system comprising a donation computing device and a plurality of devices in communication with a network.

FIG. 1A is a block diagram illustrating another embodiment of a computing system comprising a donation computing device and a plurality of devices in communication with a network.

FIG. 2 is a flowchart illustrating one embodiment of a method of allotting donation indications to a donor and tracking use of the allotted donation indications.

FIG. 3 is a flowchart illustrating one embodiment of a method of allotting donation indications to a donor.

FIG. 4 is a flowchart illustrating one embodiment of a method of including donation indications in electronic communications and tracking the use of the donation indications.

FIG. 5 is a flowchart illustrating one embodiment of a method of registering a new donee to make donations via a donation website.

FIG. 6 illustrates one embodiment of a user interface for determining a number of donation indications that are associated with various denominations of donation indications.

FIG. 7 illustrates one embodiment of toolbars associated with an email module, including a toolbar for insertion and tracking of donation indications.

FIG. 8 illustrates the toolbars of FIG. 7, wherein one embodiment of a donation indication status pane is displayed.

FIG. 9 illustrates one embodiment of an email composition interface, the exemplary interface comprising a donation indication toolbar.

FIG. 10 illustrates the email composition interface of FIG. 9, wherein an email has been composed and a donation indication has been inserted into the email.

FIG. 11 illustrates one embodiment of a verification page accessed by a donee.

### DETAILED DESCRIPTION OF PREFERRED EMBODIMENTS

Embodiments of the invention will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

In one embodiment, a donor accesses a donation computing device 100 via an interface. The donor selects a donee organization, makes a donation, and is allotted a quantity of donation indications related to the selected donee organization. The donor may then include one or more donation indications in the donor's electronic communications and/or documents that the donor sends, such as to his or her friends and/or colleagues. The donation indications provide the donor with a way to express his or her support for a donee organization. In addition, the recipients not only receive the electronic communications and/or documents, but they may also receive information about the donee organization, as well as have access to a donation web page of the donee organization. Thus, the donee organizations are able to grow their donor base through the peer-to-peer communications of its donors.

In one embodiment, the donation indications comprise an actual donation or a pledge to donate. In one embodiment, the donation or pledge relates to monetary and/or non-monetary donations to donees, such that the donation indications may be allotted to a donor in response to donations of monetary as well as non-monetary goods. For example, the donations could include airline miles, cell phone minutes, services, and/or tangible goods.

In one embodiment, the donation indications may be represented as graphical images of postage stamps that may be inserted into the electronic communications and/or documents. For example, a donation indication may comprise a jpeg or gif image comprising a stamp indicating a particular donee. In other embodiments, the donation indications may comprise other graphical or non-graphical content, such as a video or a text message, for example. The donation indications may be used with a variety of electronic communications and/or documents, such as, for example, email messages, blog postings, news group postings, bulletin board postings, MySpace postings/messages, Friendster postings/messages, webpages, text messages, other electronic files, and so forth.

It should be appreciated that the donation indication may be embodied in a two dimensional representation via any user interface technology, but that a three dimensional embodiment may also be delivered through the use of holographic imagery, laser projection, light emitting polymer/organic displays, photovoltaic cells, three dimensional florescent glass, parallax panoramagrams, heliodisplays and any other technology that enables volumetric display or representation of data and so forth. It should also be appreciated that the donation indication may be presented via an interactive volumetric embodiment, such as, for example, once a donation indication is sent to a recipient, it may arrive in the form of an interactive three-dimensional holographic image which the recipient can physically interact with, either with or without the aid of traditional input devices. Further, it should be appreciated that the donation indication may be used for a variety of purposes including, for example, advertising, fund raising, creating and/or building brand or issue awareness, political speech, peer awareness, and so forth.

### I. Example Donation System Embodiment

One embodiment of a sample donation will now be discussed to illustrate features of one embodiment of a donation system. It is recognized, however, that a variety of embodiments of a donation system may be used.

For example, Ryder, an individual, decides that he wants to make a donation to his favorite charity, the Humane Society. Ryder uses his cell phone to log onto the donation computing device website and registers as a new user. Ryder searches for the Humane Society from the list of possible donees, and then finds and selects the Humane Society. Ryder then chooses to donate $10 and selects the option of receiving the allotment of 100 ten-cent electronic Humane Society stamps. Ryder makes the donation of $10 and also pays a processing fee of fifty-cents. Ryder downloads donation tracking software and is allotted the 100 ten-cent stamps allowing him to share his passion for the Humane Society.

Ryder then prepares an email to send to his friend Chris, and in the email he inserts one of his 100 ten-cent stamps. The stamp includes the Humane Society logo and is associated with a message that reads: “I made a contribution to my favorite charity. To learn more about it, click on the stamp.” Ryder sends the email to Chris, and Ryder's total number of stamps sent is changed to one and the total number of stamps left on the roll is set to ninety-nine. Ryder has control over the stamps and can decide when and if he wants to include a Humane Society stamp.

Chris receives the email from Ryder and is interested in Ryder's donation. Chris clicks on the Humane Society stamp in the email and is directed to the Humane Society web page associated with the donation system. Chris also decides to make a donation. He creates an account, makes a donation, downloads the donation tracking software, and is allotted his electronic stamps. Chris can then create and send emails that include his electronic stamps for the Humane Society.

Chris and Ryder can continue to send emails to their friends that tell their friends about the Humane Society and give their friends a chance to also make a donation and purchase stamps from the Humane Society. When they run out of stamps, they can purchase more Humane Society stamps. They may also purchase stamps for their other favorite organizations.

The Humane Society also benefits because the donation system allows it to enlist its existing supporter, Ryder, to subtly solicit donations through his peer-to-peer communications. Moreover, because Ryder sends an average of three emails per day, the potential exposure for the Humane Society is quite large, and that is just the exposure from one donor. Moreover, Ryder's emails will likely go to potential donors that are not on the Humane Society's potential donor list. Since Ryder's email list includes friends, school colleagues, business colleagues, and family, all with different backgrounds. In addition, the Humane Society is able to engage Ryder every time he creates an email and not just when he makes a donation. Furthermore, the Humane Society is able to reach and engage a technology savvy set of donors who like using technology for giving. Also, the Humane Society may receive feedback regarding stamp usage, recipients, potential donors who decide to donate, and/or potential donors who decide not to donate, and so forth.

While the embodiments above illustrate some embodiments of a donation system, it is recognized that a variety of embodiments may be used as set forth in detail below. For example, other donation indications may be used in addition to and/or instead of electronic stamps. In addition, the donation indication may be included in a variety of electronic documents and/or communications not just email, and so forth.

### II. Donation System

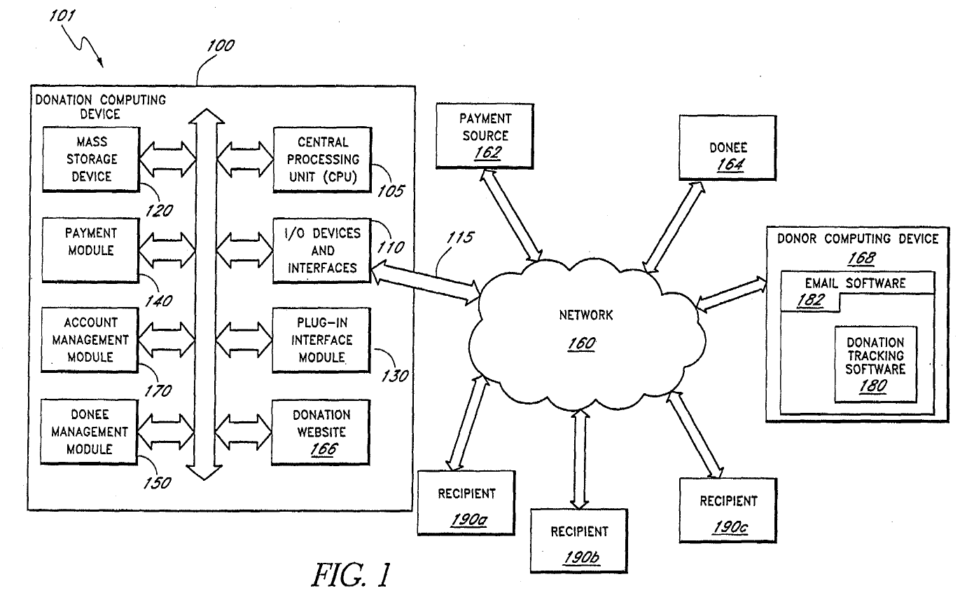

FIG. 1 is a block diagram illustrating one embodiment of a donation system 101 that includes a donation computing device 100 in communication with a network 160 and various devices. The donation computing device 100 communicates with a donor computing device 168, a payment source 162, and a donee 164, as well as recipients 190A, 190B, 190C. In other embodiments, the donation computing device 100 is in communication with fewer or additional computing devices, such as multiple payment sources, donation websites, donees, donor computing devices, and donation tracking software.

A. Donation Computing Device

In one embodiment, the donation computing device 100 performs one or more operations associated with the management of donor and donee accounts. The donation computing device 100 is configured to establish accounts for a plurality of donees, such as charities, religious organization, and other non-profit organizations, for example. In other embodiments, the donation computing device 100 may establish donee accounts with other organizations, businesses, entities, and/or individuals. The donation computing device 100 is also configured to receive donations from donors. The donation computing device 100 may receive donations via a web interface or a program module, or in any other manner. In one embodiment, the donation computing device 100 receives a selection of a donation amount and a denomination from a donor and allots a determined quantity of donation indications for the donor. In one embodiment, the donation computing device 100 calculates the allotted number of donation indications based at least partly on the donation amount and denomination selected by the donor. The donation computing device 100 then communicates a number of donation indications that have been allotted to the donor to the donation tracking software 180.

In one embodiment, the donation computing device 100 includes a donation website 166, multiple modules 130, 140, 150, 170, a mass storage device 120, input/output devices and interfaces 110, and a central processing unit 105.

1. Donation Web Site

In one embodiment, the donation website 166 comprises one or more Internet-accessible user interfaces that allow a donor to register with the donation computing device 100, make donations to a selected donee, and receive an allotted number of donation indications. In one embodiment, the donation website 166 comprises one or more databases that maintain data regarding donors and donees, such as donee payment information and information tracking remaining allotted donation indications for each donor. The donation website 166 may be maintained locally on the donation computing device 100 as shown in FIG. 1, or on a device that is in communication with the donation computing device 100.

2. Modules

In the embodiment of FIG. 1, the donation computing device 100 comprises a donee management module 150, an account management module 170, an add-in interface module 130, and a payment module 140. The functionality provided for in the components and modules of the donation computing device 100 may be combined into fewer components and modules or further separated into additional components and modules.

In general, the word module, as used herein, refers to logic embodied in hardware or firmware, or to a collection of software instructions, possibly having entry and exit points, written in a programming language, such as, for example, Java, C, C++, Lua, or C#. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. The modules described herein are preferably implemented as software modules, but may be represented in hardware or firmware. Moreover, although in some embodiments a module may be separately compiled, in other embodiments a module may represent a subset of instructions of a separately compiled program, and may not have an interface available to other logical program units.

a. Donee Management Module

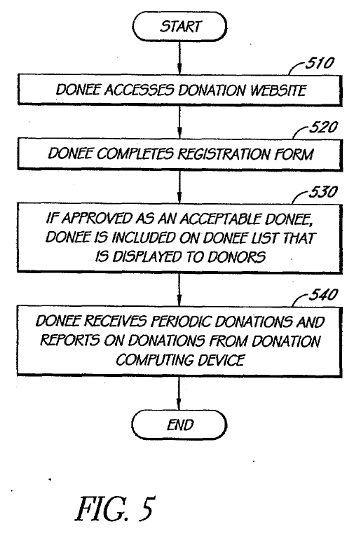

In one embodiment, the donee management module 150 is configured to receive and maintain information regarding one or more donees. For example, the donee management module 150 may receive registration information from organizations, including information such as, for example, the organization's name, address, phone number, contact person, bank account information, tax identification number, and information regarding donation indications that may be associated with the organization. In addition, the donee management module 150 may receive a logo, graphic, or other identifying data to use in the donation indications that donors send to recipients. In one embodiment, the exemplary method of FIG. 5, which comprises a donee registration process, may be at least partially performed by the donee management module 150.

The donee management module 150 may also include information regarding the donations made to donees, such as, for example, donor information, donation amounts, feedback on stamp usage, recipient information, potential donors who decide not to donate, potential donors who decide to donate, and so forth.

b. Account Management Module

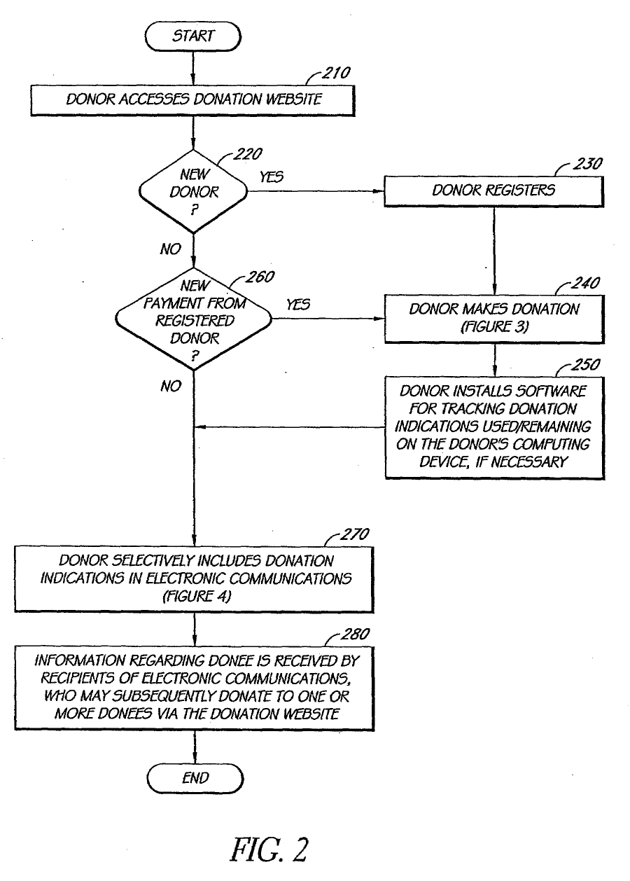

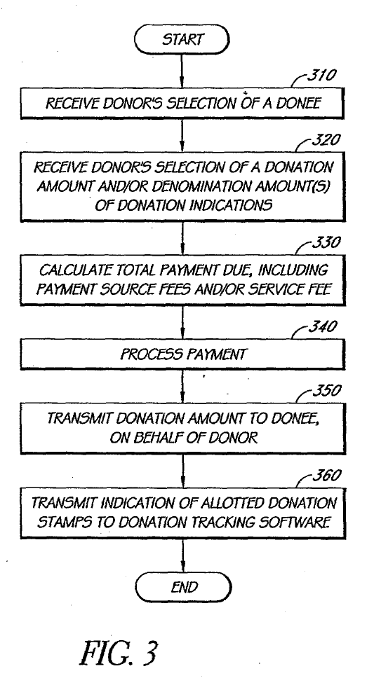

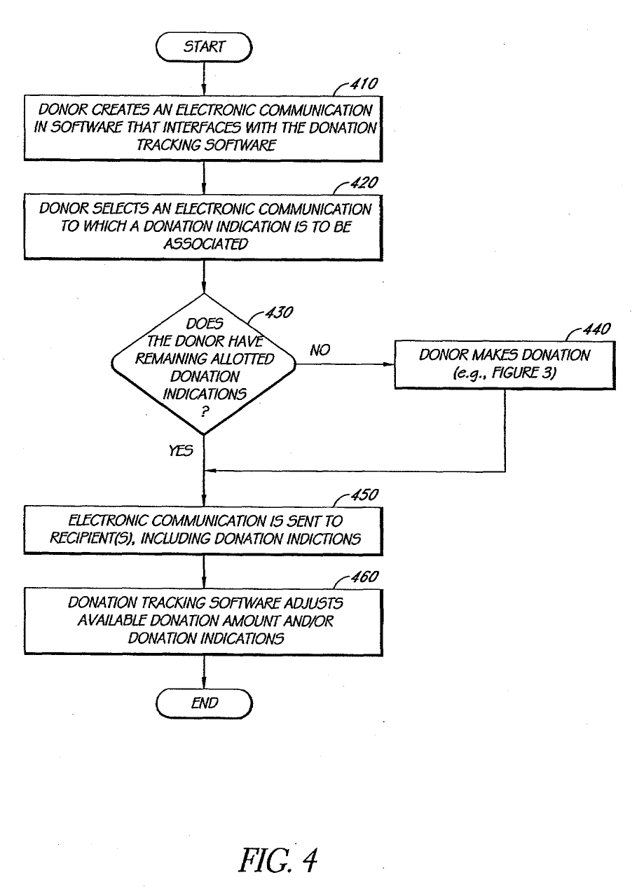

In one embodiment, the account management module 170 is configured to receive information from the donor computing device 168, and possibly from other devices, regarding a donation amount to be made to a selected one or more of the donees. The indicated donation amount may then be associated with an allotted number of donation indications. In some embodiments, the exemplary method of FIG. 3, which comprises a method that may be used to calculate the allotted quantity of donation indications based on a selected donation, may be at least partially performed by the account management module 170.

c. Interface Module

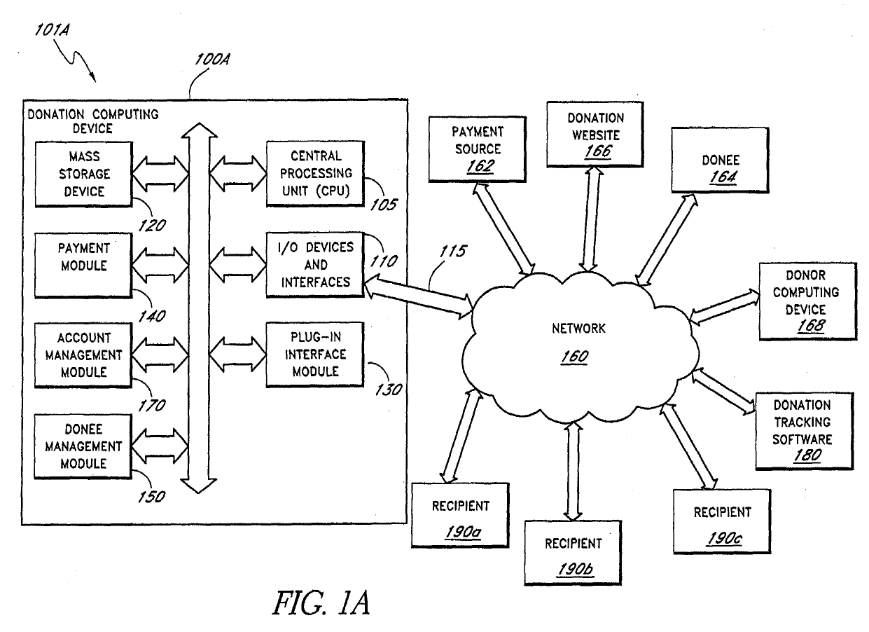

In one embodiment, the plug-in interface module 130 is configured to provide a software application, such as, for example, the donation tracking software 180, to the donor computing device 168. For example, the interface module 130 may make the donation tracking software 180 available for download by a donor or may make the donation tracking software 180 remotely available to the donor. In one embodiment, the donation tracking software 180 allows an electronic application, on the donor computing device, such as an email module, for example, to include one or more of the donation indications in selected electronic communications and/or documents sent from the electronic application. In one embodiment, the donation tracking software 180 is further configured to track a quantity of donation indications included in electronic communications and/or documents transmitted from the donor computing device 168. The donation tracking software 180 may run on the donor computing device 168, though in other embodiments it may run on the donation computing device 100 or another system. The exemplary method of FIG. 2, which comprises a process of tracking donation indications that have been used by a donor, may be performed by one or more of the interface module 130 and/or the donation tracking software 180 that is installed on the donor computing device 168. In one embodiment, the donation tracking software 180 communicates information regarding the allotted donation indications to the interface module 130.

d. Payment Module

In one embodiment, the payment module 140 receives payments from the payment source 162 for the indicated donation amount. For example, the payment module 140 may access the indicated payment source 162, such as a credit card account of the donor, in order to receive payment of the donation amount from the payment source 162. In one embodiment, the donor also pays a service fee, such as a per donation service fee or a percentage of the donation amount service fee, to the operator of the donation computing device 100. The payment module 140 may receive payment from the payment source 162 for both the donation amount and the service fee. The total amount paid to the donation computing device, referred to as a “total payment,” may comprise a donation amount, a service fee, and/or a transaction fee charged by the payment source 162.

3. System Information

In one embodiment, the donation computing device 100 runs on a device, such as, for example, a computing device or server that is IBM, Macintosh, or Linux/Unix compatible. In another embodiment, the donation computing device 100 runs on a PC, a laptop computer, cellphone, personal digital assistant, kiosk, or audio player, for example. In one embodiment, the exemplary donation computing device 100 includes one or more central processing units (CPU's) 105, which may each include conventional microprocessors or any other processing unit. The donation computing device 100 further includes one or more memory devices, such as random access memory (RAM) for temporary storage of information and read only memory (ROM) for permanent storage of information, and one or more mass storage devices 120. The mass storage device 120 may include one or more hard drives, cache memories, diskettes, or optical media storage devices. The exemplary donation computing device 100 also includes one or more input/output (I/O) devices and interfaces 110, such as a keyboard, microphone, mouse, touchpad, speaker, and printer. In one embodiment, the I/O devices and interfaces 110 include one or more display devices, such as monitors, that allow the visual presentation of data to a user. More particularly, a display device provides for the presentation of graphical user interfaces (GUIs) and application software data, for example.

In one embodiment, the components of the donation computing device 100 communicate via a standards based bus system, such as bus systems using Peripheral Component Interconnect (PCI), Microchannel, SCSI, Industrial Standard Architecture (ISA) and Extended ISA (EISA) architectures, for example. In certain embodiments, components of the donation computing device 100 also communicate via one or more networks, such as a local area network that may be secured.

In one embodiment, the donation computing device 100 is controlled and coordinated by operating system software, such as, for example, the Windows 95, Windows 98, Windows NT, Windows 2000, Windows XP, Windows Vista, Linux, SunOS, Solaris, HP-UX, PalmOS, Blackberry OS, or other compatible desktop, notebook, PDA, or server operating systems. In Macintosh systems, the operating system may be any available operating system, such as MAC OS X. In other embodiments, the donation computing device 100 may be controlled by a proprietary operating system. Conventional operating systems control and schedule computer processes for execution, perform memory management, provide file system, networking, and I/O services, and provide a user interface, such as a graphical user interface (GUI), among other things.

B. Donor Computing Device

The donation computing device 100 allows the donor to make donations using the donor computing device 168. In one embodiment, the donor computing device 168 interacts with the donation computing device 100 via the donation website 166, using a website browser installed on the donor computing device 168. Via the donation website 166, the donor uses his or her donor computing device 168 to register and select a donee. The donor may also select a monetary amount to be donated to the selected donee.

The donor may also indicate a payment source 162 from which payment to the donee should be requested, such as, for example, the donor's checking, savings, or credit card account that is held at a financial institution, or payment service account, such as a PayPal or Google Checkout account. The donor is then allotted a number of donation indications.

In one embodiment, the donor then creates electronic communications and/or documents on the donor computing device 168 and inserts one or more of the donation indications into the created electronic communication. For example, in one embodiment the donor may create emails having donation indications included in the emails, wherein the emails may be transmitted to one or more recipients 190, such as one or more of the recipients 190A, 190B, and 190C. In certain embodiments, the donation indications include information regarding the donee to which the donor made a donation, as well as a link to the donation website 166, which provides further information regarding the donee.

In one embodiment, the donor computing device 168 includes email software 182 and donation tracking software 180, which are each discussed in further detail below.

1. Email Software

In certain embodiments, the donor computing device 168 comprises email software 182 installed on the device. In one embodiment, the email software 182 comprises any commercially available email program, such as Microsoft® Office Outlook, Outlook Express, Pegasus, Microsoft® Entourage, or Mac Mail, for example and/or custom built and/or proprietary software. In other embodiments, the donor computing device 168 comprises or has access to other software for creating electronic communications and/or documents in which the donation indications may be used, such as, for example, SMS, messaging software, webpage creation software, and so forth.

2. Donation Tracking Software

In one embodiment, the donation tracking software 180 allows the donor to insert donation indications into electronic communications and/or documents and monitors the number of donation indications included in the donor's electronic communications and/or documents. For example, the donation tracking software 180 may track a number of donation stamps that are included in emails sent from the donor computing device 168.

In one embodiment, the donation tracking software 180 is installed as an add-in to the email software 182 or other electronic communication software installed on the donor computing device 168. For example, in one embodiment the donation tracking software 180 comprises a toolbar plug-in that may be installed for operation in the email software 182, such as Microsoft® Office Outlook or Outlook Express. In certain embodiments, such as where the donation tracking software 180 interfaces with Outlook Express, for example, application hooks may be used to provide an interface between the donation tracking software 180 and the electronic communication software. In other embodiments, the donation tracking software 180 is installed as a standalone application on the donor computing device 168. In another embodiment, the donation tracking software 180 is not installed on the donor computing device 168, but instead is installed on a server or other network device that is in communication with the donor computing device 168. In one embodiment, the donor computing device 168 receives the donation tracking software 180 from the donation computing device 100 and/or the donation website 166 may have a link to download the source code for installing the donation tracking software 180.

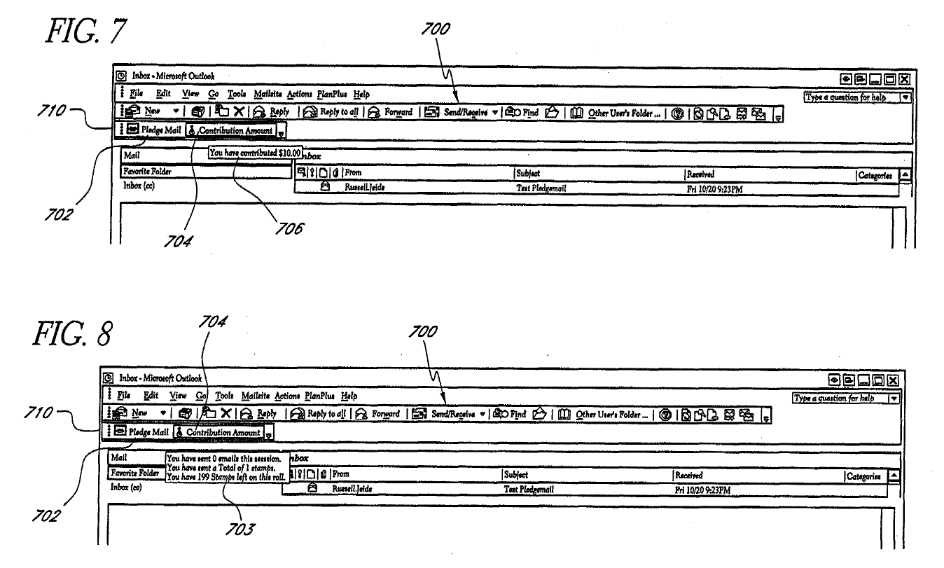

In one embodiment, the donation tracking software 180 is installed as part of and/or works in conjunction with the email software 182. For example, the donation tracking software 180 may be installed as a toolbar, add-in, plug-in, and/or menu items that are accessible via the email software 182. Such a toolbar may provide options for tracking and reporting a number of donation indications that are included in electronic communications sent from the donor computing device 168 and/or a number of remaining allotted donation indications, as well as options for including donation indications in electronic communications. FIGS. 7-10, described in further detail below, illustrate exemplary embodiments of toolbars of one embodiment of the donation tracking software 180. As noted above, in other embodiments the donation indications may be included in other electronic communications in addition to email. For example, in certain embodiments, donation indications may be included in a blog posting, a text document, a text message, and/or a website posting, for example. In some embodiments, a donor may insert donation indications into one type of electronic communication and/or document or more than one type of electronic communication and/or document.

3. System Information

In one embodiment, the donor computing device 168 runs on a computing device or server that is IBM, Macintosh, or Linux/Unix compatible. In another embodiment, the donor computing device 168 runs on a PC, a laptop computer, cellphone, personal digital assistant, kiosk, or audio player, for example. In one embodiment, the exemplary donor computing device 168 includes one or more central processing units (CPU), which may each include conventional microprocessors or any other processing unit. The donor computing device 168 further includes one or more memory devices, such as random access memory (RAM) for temporary storage of information and a read only memory (ROM) for permanent storage of information, and one or more mass storage devices. In one embodiment, the components of the donor computing device 168 communicate via a standards based bus system, such as bus systems using Peripheral Component Interconnect (PCI), Microchannel, SCSI, Industrial Standard Architecture (ISA) and Extended ISA (EISA) architectures, for example. In certain embodiments, components of the donor computing device 168 may also communicate via one or more networks, such as a local area network that may be secured.

In one embodiment, the donor computing device 168 is controlled and coordinated by operating system software, such as the Windows 95, Windows 98, Windows NT, Windows 2000, Windows XP, Windows Vista, Linux, SunOS, Solaris, PalmOS, Blackberry OS, or other compatible desktop, notebook, PDA, or server operating systems. In Macintosh systems, the operating system may be any available operating system, such as MAC OS X. In other embodiments, the donation computing device 100 may be controlled by a proprietary operating system. Conventional operating systems control and schedule computer processes for execution, perform memory management, provide file system, networking, and I/O services, and provide a user interface, such as a graphical user interface (GUI), among other things.

C. Donee

In one embodiment, donees 164 are organizations, such as charities, religious organizations, schools or other educational institutions, other non-profit organizations, other organizations, businesses, entities, and/or individuals. In some embodiments, the donees operate donee computing systems that communicate with the donation computing device 100 to register, to receive donation payments from the donation computing device 100 and/or a payment source 162, and/or to receive feedback form the donation computing device 100 regarding the donee's donations.

D. Recipients

In one embodiment, recipients 190A, 190B, 190C are entities, such as businesses, organizations, and/or individuals that receive electronic communications and/or documents from the donor computing device 168, wherein the electronic communications and/or documents include a donation indication such as an electronic stamp. The recipients 190A, 190B, 190C may receive and/or access electronic communications and/or documents with the donation indication in a variety of manners such as, for example, via email, blog postings, web postings, SMS messages, phone messages, instant messages, and so forth. In one embodiment, the recipients may use the donation indication to access a website of the donee. From the website, the recipient may choose to make a donation and receive its own set of donation indications.

E. Network

In one embodiment, the network 160 is used to facilitate communication between the donation computing device 100, the donor computing device 168, the donee 164, the payment source 162, and/or the recipients 190A, 190B, 190C. The network 160 may include one or more electronically connected networks, such as, for example, a virtual private network, a public Internet, a private Internet, a secure Internet, a private network, a public network, a value-added network, a wired network, a wireless network, an intranet, and the like. The connectivity to the network may be, for example, via modem, Ethernet (IEEE 802.3), Token Ring (IEEE 802.5), Fiber Distributed Datalink Interface (FDDI) or Asynchronous Transfer Mode (ATM). Components may communicate with the network 160, for example, by use of a modem or by use of a network interface card that resides in the components.

### F. Other Embodiments

FIG. 1A is a block diagram illustrating another embodiment of a donation system 101A comprising a donation computing device 100A and a plurality of devices in communications via a network 160. In the embodiment of FIG. 1A, the donation computing device 100A comprises many of the same components and modules as the donation computing device 100 of FIG. 1. In the exemplary embodiment of FIG. 1A, the donation computing device 100 is in communication with a payment source 162, a donee 164, and a donor computing device 168. However, in FIG. 1A, the donation website 166 communicates with the donation computing device 100 via the network 160. Thus, in embodiment of FIG. 1A, the donation website 166 is maintained remote from the donation computing device 100A. Moreover, in the embodiment of FIG. 1A, the donation tracking software 180 runs independent of the donor computing device 168.

While various embodiments of a donation system 101, 101A have been discussed, it is recognized that there are many embodiments of a donation system and that the donation system is not limited to the embodiments of 101, 101A. Operation of embodiments of the components of FIGS. 1 and 1A will be described in further detail below.

### II. Allotting Donation Indications and Tracking Uses

FIG. 2 is a flowchart illustrating one embodiment of a method of allotting donations indications to a donor and tracking use of the allotted donation indications. In one embodiment, one or more blocks indicated in FIG. 2 are performed by the donation computing device 100 or 100A. In other embodiments, other computing devices may perform certain blocks of the method illustrated in FIG. 2. Depending on the embodiment, additional or fewer blocks may be added or removed, and the order to the blocks may be changed, from the method illustrated in the flowchart of FIG. 2.

Beginning at block 210, a donation website, such as an Internet accessible webpage that is viewable in a browser running on a donor computing device is provided to a donor. As indicated above, in one embodiment the donation website 166 is in communication with the donation computing device 100. Thus, information provided to the donation website 166 is communicated to the donation computing device 100, and information is transmitted from the donation computing device 100 to the donation website 166, wherein the transmitted information may be displayed to the donor via the donation website 166. In some embodiments, the donation website 166 is included in the donation computing device 100, whereas in other embodiments, the donation website 166 is separate from the donation computing device 100. Thus, references herein to operations performed by the donation website 166 may comprise operations performed partially or completely by the donation computing device 100 in communication with the donation website 166.

Continuing to block 220, the donation website 166 determines if the donor has registered with the donation computing device 100. In one embodiment, a user interface of the donation website 166 comprises a link that may be selected by the donor in order to indicate that the donor has not yet registered with the donation computing device 100. In other embodiments, the donation website 166 may store cookies, or other identifying information, on the donor computing device 168 in order to identify registered donors when they return to the donation website 166. If the donation website 166 determines that the donor is a new donor, the method continues to block 230. where the donor is registered. If the donor is already registered, however, the method continues to a block 260 where the donation website 166 determines if a new payment from the registered donor is requested and/or required.

In block 230, a new donor is registered with the donation computing device 100 via the donation website 166. In one embodiment, for example, one or more user interfaces of the donation website 166 comprise data entry fields and/or other input controls that are completed by the donor in order to register the donor. In one embodiment, a registration form comprises data entry fields and possibly one or more drop-down lists that allow the donor to supply the required information to the donation website 166. The donor may be required to provide contact information, such as a name and physical address, and payment information, such as a credit card account number. In other embodiments, additional or less information is required in order to register a donor with the donation computing device 100.

Continuing to block 240, the donor makes a donation to a selected donee. FIG. 3, described in further detail below, provides further description of one embodiment of receiving a donation from a registered donor. In one embodiment, the donor indicates a donation amount and a quantity of donation indications are allotted to the donor, wherein the donation indications may be included in one or more types of electronic communications.

Moving to block 250, software for tracking donation indications used and/or remaining is installed on the donor computing device 168, if necessary. For example, in one embodiment the donation tracking software 180 comprises a plug-in that may be installed on the donor computing device 168 and configured to interface with the email software 182. In other embodiments, the donation tracking software 180 may be configured to interface with other electronic communication software and the donation tracking software 180 may be installed as a standalone program that monitors electronic communications, rather than a plug-in that interfaces directly with the electronic communications software. In one embodiment, the donation tracking software 180 comprises code stored on a computer readable medium, the code being configured for transmission to the donor computing device 168 for installation on the donor computing device 168. In one embodiment, multiple copies of the donation tracking software 180 may access a common donor account from different computing devices. For example, in this embodiment the donor may install the donation tracking software 180 on a work computer, a home computer, and a smart phone, for example.

After receiving the software in block 250, the method continues to a block 270 where the donor is able to include donation indications in electronic communications.

Returning to block 220, if the donor accessing the donation website 166 is a registered donor, the donor may be asked to sign in to the donation website 166, such as by entering a username and password. In other embodiments, the donor may be automatically authenticated by the donation website 166, such as via the donation website 166 associating an IP address of the donor computing device 168 with a registered donee. Alternatively, a cookie, or other account identifier, may be stored on the donor computing device 168 such that the donation website 166 accesses the cookie when the donation website 166 and/or the donation computing device 100 are accessed by the donor computing device 168 in order to authenticate the registered donor and bypass a manual login process. In block 220, after the registered donor has been authenticated by the donation website 166, the method continues to block 260, where the donor is provided with an opportunity to make a payment comprising a donation to one or more donees. In one embodiment, the donation website 166 indicates to the registered donor a remaining number of allotted donation indications. In one embodiment, when the remaining donation indications reach a low level, such as only 10 of 100 donation indications remaining, for example, the donor may desire to make a payment for additional donation indications. In one embodiment, the donation website 166 comprises one or more selectable links that present the donor with donation options, such as a user interface that allows the donor to select a donee, and one or more controls that allow the donor to select a donation amount. The method then proceeds to block 240 where the donor makes a donation and then to block 250 where new and/or updated donation tracking software 180 may be installed on the donor computing device 100, if necessary.

In block 270, the donor is able to selectively include donation indications in electronic communications and/or documents. For example, in one embodiment, the donor is able to include donation stamps in emails. As described further with respect to FIG. 4, in one embodiment the donation tracking software 180 includes a toolbar, or other selection control, that may be selected by the donor in order to insert one or more donation indications into an electronic communication. In other embodiments, donation indications may be inserted into electronic communications in other manners, such as in response to a keyboard shortcut or by typing a predefined character string, for example. In other embodiments, the donation indication may, by default, be included in one or more types of electronic communications and/or documents.

Moving to block 280, information regarding the donee is received by recipients 190 of the donor's electronic communications and/or documents. The recipients 190 may subsequently donate to one or more donees via the donation website 166 via a link that is sent with the donation indication. For example, in an embodiment where the donation indication comprises a graphical image, a link to the donee may be associated with the graphical image, such that when the graphical image is selected a website providing further information regarding the donee may be loaded in a recipient's web browser. In other embodiments, the donation indications may be associated with a pop-up informational window that provides information regarding the donee when the mouse cursor hovers above the donation indication, for example. In other embodiments, the donation indication may also include information about the donee.

### III. Allotting Donation Indications

FIG. 3 is flowchart illustrating one embodiment of a method of allotting donations indications to a donor. As described above with respect to FIG. 2, when a donor makes a donation, the donor is allotted a quantity of donation indications. In one embodiment, each of the donation indications corresponds with an equal fraction of the total donation amount. For example, in one embodiment if the donation amount is $10, the donor may elect to be allotted 100 ten-cent donation indications or 50 twenty-cent donation indications. Thus, in this embodiment each of the donation indications is associated with an equal value. In other embodiments, the donor may select varying donation amounts to associate with each of the donation indications.

Beginning in a block 305, a list of donees is presented to the donor, such as via a web interface of the donation website 166 (FIG. 1). In one embodiment, donees that are registered with the donation computing device 100 are displayed to the donor, such as in a drop down list, through which the donor can select a particular donee. In another embodiment, both registered and unregistered donees may be displayed to the donor for selection. In one embodiment, the donor may reduce a number of donees that are displayed for selection by selecting one or more donee filters based on, for example, geographic location of the donee and/or donor, a donee entity type, and/or a donee mission statement. In other embodiments, the donee list may be presented to the donor in other forms, such as in a printed form that may be mailed to the donor, for example.

Beginning at block 310, the process receives a selection of a donee to which a donation is to be transmitted from the donor. In one embodiment, a list of donees is provided on the donation website 166. In this embodiment, the donor may select a donee by clicking on, or otherwise selecting, text and/or a graphical image associated with the desired donee. In other embodiments, the donees may be associated with identification codes that may be entered by the donor in order to select a particular donee. In one embodiment, the donor may select a donee by interfacing with the donation tracking software 180. For example, the donation tracking software 180 may comprise drop-down menus listing donees, such as donees to which the donor has previously donated or donees associated with a certain cause.

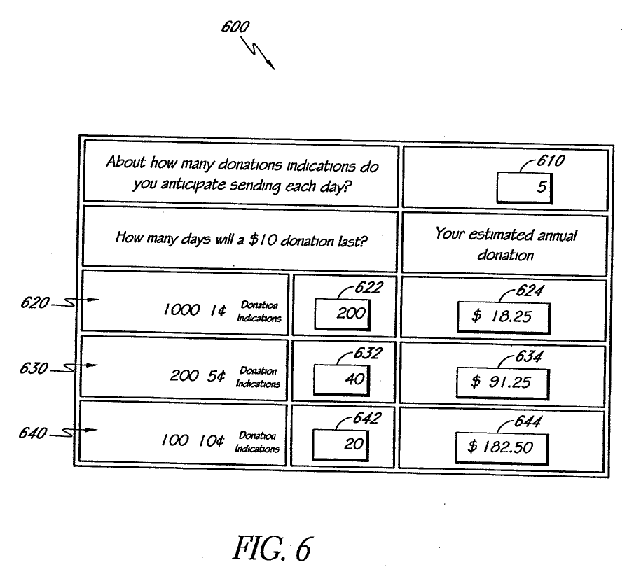

Continuing to block 320, the process receives a selection of a donation amount and/or denomination amount of donation indications. As noted above, in one embodiment the donor selects a denomination amount that is associated with each donation indication. For example, the donor may indicate that each donation indication is associated with a 10, 20, 25, or 50-cent donation. Additionally, the donor indicates a total donation amount, such as $10, $20, $50, $100, or $500, for example. To assist the donor, the donation computing device 100 may provide the donor with access to an electronic donation calculator that helps estimate the donor's donation, such as, for example, the donor's annual donation and/or the time period a particular donation will last. One embodiment of an electronic donation calculator is discussed below with respect to FIG. 6.

Next, in block 330, the process calculates a total payment due from the donor, including payment source fees and or a service fee, if applicable. Certain payment sources 162 charge a fee to the recipient of a payment. For example, a payment source 162 may charge the operator of the donation computing device 100 a fee for each payment that is transmitted to the donation computing device 100. In one embodiment, the donation computing device 100 includes any transaction fees that will be due to the payment source 162 in the calculated total payment. In one embodiment, the process adds a service fee portion to the donation amount and any payment source transaction fees. In one embodiment, the service fee comprises a flat fee for each donation, such as one dollar per donation received from a donor. In another embodiment, the service fee comprises a percentage of a particular donation, such as 3% of a donation. In other embodiments, registered donors may pay a periodic membership fee in order to use the features provided by the donation computing device 100. Thus, in this embodiment, a service fee may be included only on a first donation received from the donor in each period.

Moving to block 340, the process retrieves the payment from the payment source 162. As noted above, the payment source 162 may comprise any financial institution, such as a bank, credit card company, or online payment service. For example, in one embodiment payment and/or payment information is received from an online payment service, such as PayPal or Google CheckOut using the donor's account information, and/or from a credit card company or financial institution, using the donor's credit card number and expiration date.

Continuing to block 350, the process transmits the donation amount to the selected donee, on behalf of the donor. As noted above, in one embodiment the total payment received from the donor comprises not only the donation amount, but also a payment source transaction fee and/or a service fee. Thus, in block 350, the donation computing device 100 transmits only the donation amount to the donee. In one embodiment, the donation amount is transmitted to the donee electronically, such as via an electronic check, a credit card payment, an electronic funds transfer, or using an online payment service, such as PayPal or Google CheckOut. In other embodiments, the donation amount may be transmitted to the donee via more traditional means, such as via a check that is sent in the mail, or via other package delivery companies.

In block 360, the process transmits an indication of the allotted donation indications to the donation tracking software 180. In one embodiment, the donation tracking software 180 monitors the use of donation indications in electronic communications and/or document, such that only the allotted quantity of donation indications may be included in electronic communications and/or document. In one embodiment, the donation tracking software 180 comprises a toolbar, or other user interface, that provides an indication of the allotted quantity of donation indications. Additionally, the donation tracking software may include other features, such as a link to the donation website 166 and an indication of the donation amount that was previously transmitted to the donation computing device 100.

In other embodiments, stamps, or other indicators, may be allotted to an individual in exchange for other services, such as use and/or contribution to a particular website. For example, users of a social networking website or a wiki may earn the right to use various indicators in electronic communications based on a level of use or expertise that the individual provides. In one embodiment, various indicators are associated with respective knowledge levels that are indicative of a user's contributions to the provider, such as a website or wiki. In this embodiment, the individual may include the indicators in electronic communications in order to indicate their level of contribution, for example, and to encourage others to contribute to the provider also.

In another embodiment, a quantity of stamps, or other indicators, may be allotted to an individual by a commercial entity for no charge. In this embodiment, when the individual has transmitted the allotted quantity of indicators, the commercial entity may provide the individual with monetary compensation or prizes, such as coupons for discounts and/or free items at the commercial entity. In a similar embodiment, a plurality of individuals may each be provided with an endless quantity of indicators to use within a predetermined time period. In this embodiment, the individual that transmitted the greatest quantity of indicators may be rewarded with monetary compensation or other prizes.

### IV. Sending Donation Indications

FIG. 4 is a flowchart illustrating one embodiment of a method of including one or more donation indications in electronic communications and tracking use of the donation indications. Beginning in a block 410, the donor creates an electronic communication and/or document in software that interfaces with the donation tracking software 180. For example, the electronic communication software may comprise email software 182 that is installed on the donor computing device 168 and the electronic communication and/or document may comprise an email. In this embodiment, the donation tracking software 180 interfaces with the email software 182 so that donation indications may be included in emails sent by the email software 182, and the use of donation indications may be tracked by the donation tracking software 180. In other embodiments, the communication software comprises a user interface that is viewable in a browser, such as blog or Internet chat software. In these embodiments, the donation tracking software 180 may be installed as a plug-in to a browser or as a standalone program that interfaces with the browser, for example.

Continuing to a block 420, the donor selects an electronic communication and/or document. For example, the donor may choose specific electronic communications, such as emails that he or she wants to use with its donation indications. In one embodiment, a donor chooses to insert a donation indication into an email by selecting a button that interfaces with the donation tracking software 180, such as a button on a toolbar that is installed by the donation tracking software 180. Alternatively, other inputs may be used to indicate to the donation tracking software 180 that a donation indication is to be inserted into an electronic communication and/or document. For example, a shortcut key on a keyboard may be defined to indicate that a donation indication should be inserted into a selected electronic communication and/or document. In some embodiments, the donation indication is inserted, attached to, embedded, and/or so forth into the electronic communication and/or document such that the donation indication cannot be copied and/or removed and/or pasted into another document.

Moving to a block 430, the donation tracking software 180 determines if the donor has adequate remaining allotted donation indications. For example, if the donor transmitted a payment to the donation computing device 100 for one hundred donation indications and the donor subsequently transmitted electronic communications including one hundred donation indications, the donation computing device 100 determines that the donor does not have enough remaining allotted donation indications and the method continues to a block 440 where the donor may transmit an additional donation and receive an additional allotment of donation indications. In one embodiment, the donor makes an additional donation using a method such as the method described with respect to FIG. 3, above. In other embodiments, the donor may make an additional donation using features that are built into the donation tracking software 180, without needing to visit the donation website 166. After making another donation, the method continues to a block 450. Similarly, if the donation tracking software 180 determines that the donor has remaining allotted donation indications, the method continues to block 450.

In block 450, the electronic communication and/or document including the donation indication is transmitted from the donor computing device 168. For example, an email created comprising a graphical donation indication may be transmitted from the donor computing device 168 via a connection to the Internet. Alternatively, the electronic communication and/or document may be transmitted within a local area network, wide area network, or any other combination of computing devices. In one embodiment, one or more recipients of the electronic communication and/or document comprise mobile devices, such as a cellular telephones, smart phones, or PDAs.

Continuing to a block 460, the donation tracking software 180 adjusts an available quantity of donation indications that may be included in electronic communications. For example, if the donor is allotted 50 donation indications in response to payment of a donation amount to the donation computing device 100, the donor initially has 50 available donation indications. When the donor transmits an electronic communication including a single donation indication, the donation tracking software 180 reduces the quantity of available donation indications to 49 (50−1=49). Similarly, if the donor then transmits two additional donation indications in an electronic communication, the quantity of available donation indications is reduced to 47 (49−2=47).

In one embodiment, the donation tracking software 180 tracks a remaining donation amount that may be used in donation indications. For example, the donation tracking software 180 may initially receive an indication that a five dollar donation has been paid by the donor. When the donor includes a twenty five-cent donation indication in an electronic communication, the remaining donation amount is reduced to $4.75 ($5.00−$0.25=$4.75). Likewise, if the donor then includes three donation indications in an electronic communication, the donation amount is further reduced to $4.00 ($4.75−$0.75=$4.00). In one embodiment, the donation indication amount associated with donation indications may be adjusted by donor, such as on a per email basis. In this embodiment, the donor may select a different donation indication amount for each donation indication. For example, the donor may include a donation indication having an associated value of three-cents in a first email and a donation indication having an associated value of thirty-cents in a second email. Similarly, in one embodiment the donor may include multiple donation indications in a single electronic communication, such as a five-cent and a ten-cent donation indication in a single email.

In one embodiment, the donation tracking software periodically transmits to the account management module 170 one or more status indicators indicating a number of donation indications that were included in electronic communications sent from the donor computing device 168 since the last periodic status indicator(s) were transmitted. In this embodiment, the account management module 170 can track the remaining number of donation indications that have been allotted to each donor.

In one embodiment, the donor may send an email or other electronic communication including a set of stamps and/or a link to retrieve a set of stamps that may be used by a recipient. For example, donor A may send her friend an email that includes one donation stamp, but may also include in the email a link to the donation website such that when the friend accesses the donation website, using for example, her email address, the friend receives a version of the donation tracking software 180 and is provided with a set of stamps that have already been purchased by donor A. Thus, the friend can now send her own stamps.

### V. Registering a Donee

FIG. 5 is a flowchart illustrating one embodiment of a method of registering a new donee so that the donee may be included on a donee list that is displayed to donors and/or receive more detailed donor information. In one embodiment, a donee meets certain qualifications for being included on any donee lists. In one embodiment, the donation website 166 communicates donee information to the donee management module 150 (FIG. 1). In other embodiments, donees are not required to be registered with the donation website 166 in order to be listed on a donee list and/or to receive donations from one or more donors. In one embodiment, the donation website 166 may include a listing of organizations, such as charities, that are registered with a governmental taxing entity as not for profit organizations, or organizations that are listed on any other relevant list. Likewise, any other organizations, such as school districts or religious organizations, may be added to the donee list without requiring registration from the listed donees. In one embodiment, the donees that are included in a donee list that is displayed to a particular donor are filtered according to one or more criteria, such as donation interests of the donor and/or geographic proximity of the donees to the donor. In embodiments where filtering of the donee list is used, the donor may be presented with a shorter, more relevant, list of donees. In one embodiment, registered donees are noted on the donee list displayed to potential donors, such as by shading the registered donees, for example.

In one embodiment, a donee registers with the donation website 166 in order to receive a comprehensive report regarding donors and corresponding donations that have been made to the donee. The comprehensive report may include, for example, contact information of the donors that have donated to the donee, such as an email and residence address, statistics regarding donation indications purchased and used by donors, and statistics regarding donors that have considered donating to the donee (such as by viewing additional information regarding a donee) and those that actually have donated to the donee. In one embodiment, a comprehensive report may be generated for a registered donee at any time after the donee has been authenticated with the donation website 166, such as by logging into a donee specific portion of the donation website 166. The comprehensive report may be viewable in a web browser, or may be in any other format that may be transmitted to the donee. In another embodiment, periodically updated comprehensive reports may be mailed or emailed to registered donees. In one embodiment, donees that are not registered may receive a basic report, which does not include all of the information in the comprehensive report that is provided to the registered donees. The basic report may include, for example, only an email address of donors that have donated to the donee. The basic report may also comprise an invitation for the unregistered donor to register with the donation website 166 in order to receive comprehensive reports regarding donation activities. The contact information included on either the basic or comprehensive report may be used by donees to send notices of gratitude to their respective donors, for example. Such acknowledgments of gratitude from the donee may increase the donors likelihood to make additional donations to the donee and/or to encourage increased use of donation indications in electronic communications transmitted by the donor.

Beginning in a block 510, the donee accesses the donation website 166, or other interface that is configured to receive registration information from new donees. In one embodiment, the donation website 166 is associated with a URL that provides the donee with a registration form. For example, in one embodiment the registration form comprises one or more user interfaces that may be displayed in an Internet browser. In one embodiment, the registration form comprises data entry fields and possibly one or more drop-down lists or other controls that allow the donor to supply the required information to the donation website 166.

Continuing to a block 520, the donee completes the provided registration form, which may comprise one or more pages and/or user interfaces. In one embodiment, the registration form comprises data entry fields for entry of a donee name, a donee address, a tax exempt status of the donee, and a mission statement of the donee, for example. In other embodiments, less and/or additional information may be required of the potential donee in the donee registration form.

Moving to a block 530, the donee management module 150 of the donation computing device 100 determines if the donee meets the requirements for registration and should be included on one or more registered donee lists and/or be highlighted in donee lists including both registered and unregistered donees. As noted above, in certain embodiments even unregistered donees may be selectable by donors from one or more donee lists, but registration may provide additional reporting features to the registered donee. In one embodiment, only those donees, whether registered or unregistered, that are nonprofit organizations are approved as acceptable donees for display to potential donors. In other embodiments, only donees within specific geographic regions or having certain mission statements may be determined to be acceptable donees. In other embodiments, any organization and/or individual may become a registered donee simply by completing the information required on the donee registration form. If the potential donee is approved as an acceptable donee, the new donee is registered with the donee management module 150 and is included on one or more registered donee lists that are presented to donors.

Next, in a block 540, the donee receives periodic donations from donors and reports regarding donations from the donation computing device 100. In one embodiment, the donee may elect to have a daily, weekly, monthly, quarterly, or yearly report indicating a total donation amount that has been transmitted to the donee from the donation computing device 100. As noted above, a comprehensive report that is accessible to registered donees may include an indication of a quantity of donation indications associated with the particular donee that have been included in electronic communications and/or that remain to be used by donors, as well as other statistics regarding donations to the registered donee.

### VI. Back-end Processing

In one embodiment, the donation computing device 100 is configured to maintain information regarding donations received for each of multiple donees and periodically provide donated funds, or other goods, to the respective donees. The donation computing device 100 may provide the donation finds to respective donees via any means of money transfer, such as electronic funds transfer or mailing of a printed check or money order. Depending on the means for transferring donation funds to donees, transferring of each and every donation to the donee immediately after receiving the funds at the donation computing device 100 may be procedurally complex. For example, if the funds are transferred via printed checks, a donee that receives multiple donations per day may have multiple checks per day printed and mailed to them. Accordingly, in another embodiment, any donation funds (the donation amount portion of the total payment) received for a donee are accumulated for a predetermined period of time and/or until an accumulated donation amount to be paid to the donee reaches a predetermined level prior to transmitting the accumulated donation amount to the donee. For example, in one embodiment the donation computing device 100 may send checks or electronic payment to each of the donees on a periodic basis, such as weekly, monthly, or semi-annually, for example. In another embodiment, donation payments are sent on a periodic basis only to those donees for which a predetermined amount of donation funds have accumulated. For example, the donation computing device 100 may be configure to send periodic donation payments (for example, each 30, 60, or 90 days) to each donee that has an accumulated donation amount of greater than $100 (or any other amount) since the last donation payment was sent to the donee. In another embodiment, the threshold amount for initiating payment of the accumulated donation amount to a donee changes depending on a time since the last payment was made. For example, a payment may be made to a donee 30 days after receiving a first donation, provided the accumulated donation amount is greater than $100, but a payment may be made to the donee after 60 days if the accumulated donation amount is greater than $75, and after 90 days if the accumulated donation amount is greater than $50. In another embodiment, the donation computing device 100 may initiate payment to a donee based only on the total accumulated donation amount for the donee, such that a payment is made to the donee whenever the accumulated donation amount reaches a predetermined threshold, such as $100, $200, or $500, for example.

In one embodiment, the donation computing device 100 also sends the donee a generated code with the payment. This generated code could be sent to registered as well as unregistered donees and may indicate whether a donee is registered or unregistered. The donee may then use the code to access information about the donor(s) related to the payment and/or to receive information and/or links to become a registered donee. As noted above, in one embodiment, a registered donee may have access to more donor information than a non-registered donee. In addition, the code helps provide a verification and/or security feature to the donation computing device 100. Thus, by having the donee use the code to access the donor information, the donation computing device 100 can encourage the donee to become a registered donee, to send the donee information about the donor(s), and/or to confirm to the donor(s) that the donation made it to the intended recipient.

As one example, the donation computing device 100 may send a $100 check to the Make-A-Wish foundation with a note stating “Enclosed is a donation to your organization. For more information on the donation, please log onto our website and enter the following code: 2867103S82.” The Make-A-Wish foundation may then access a website, such as for example via a “check verification page,” enter the code, and then receive a message stating:
Thank you for visiting our website. We are proud to inform you that Ms. Jane Nguyen made a $50 donation to your organization, Mr. Robert Katz made a $25 donation to your organization, and Ms. Taylor Jones made a $25 donation to your organization. Click on the following link if you would like their email addresses so that you can send them a thank you email. However, if you are interested in receiving additional contact information for the donors, including a mailing address, please follow the steps below to become a registered donee.

The Make-A-Wish foundation can then register on the website and then receive mailing addresses for Ms. Nguyen, Mr. Katz, and Ms. Jones. While the example above includes one example set of information provided to the donee, it is recognized that a variety of different information may be provided. In addition, different and/or additional donor information may be provided to unregistered donees and/or to registered donees.

In one embodiment, the donation computing device 100 also sends the donor one or more messages that the donation will be sent to the donee, has been sent to the donee, and/or has been received by the donee. The messages may be sent to the donor via a variety of communication channels, such as, for example, via email, phone, SMS messages, instant messages, mail, and so forth. In one embodiment, the message may include one or more of the following messages: a message sent before the payment has actually been made indicating that a payment will be made in the future and/or within a certain time frame, such as, for example, within the next 30 days, 60 days, 90 days, and so forth; a message sent after the payment is actually made to the donee indicating that the payment had been sent; and/or a message sent after the payment has been received by the donee.

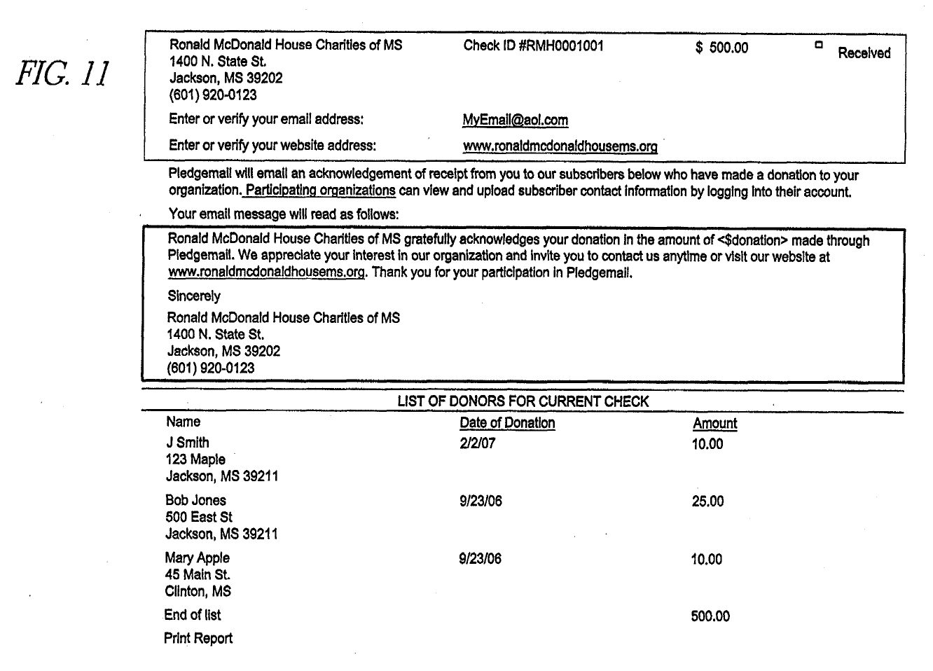

One embodiment of a verification page accessed by a donee is shown in FIG. 11. The information includes a statement that receipt by the donee will be emailed to the subscribers and provides an example email that will be sent. In addition, it provides a list of donors that contributed to the current check. It is recognized that FIG. 11 illustrates one embodiment of information provided to the donee and that a variety of information may be provided in a variety of formats.

### VII. Donation Calculator

FIG. 6 illustrates one embodiment of a user interface 600 for determining a number of donation indications that are associated with various denominations of donation indications. In one embodiment, when the donor makes a new donation, such as by using the method indicated in FIG. 3, for example, the donation computing device 100 presents a user interface that determines various donation amounts that are associated with denomination amounts and a quantity of emails that are sent per day by the donor. More specifically, in the embodiment of FIG. 6, the user interface 600 is configured to aid the donor in determining a donation amount and an associated denomination amount for donation indications that may be included in emails, for example.

In the embodiment of FIG. 6, a data entry field 610 receives an input from an input device coupled to the donor computing device 168. In the exemplary user interface 600, the donor has entered the quantity “5” in the data entry field 610. In the exemplary embodiment of FIG. 6, the user interface 600 is configured to determine how many days a $10 donation will last, based on the received quantity in the data entry field 610. For example, in a first results row 620, the user interface calculates a quantity of days that a $10 donation will last if the donor uses five donation indications each day and the donation indications are each associated with a one-cent value. As shown in text field 622, one thousand one-cent donation indications would last the donor 200 days, assuming five donation indications are used each day. In the embodiment of FIG. 6, the user interface 600 also indicates an estimated annual donation based upon the information entered in the data entry field 610 and depending on the denomination of donation indications. Thus, in row 620, the estimated annual donation field 624 indicates that, should the donor transmit an average of five one-cent donation indications each day, the donor would need to donate a total of $18.25 each year. The user interface 600 further comprises rows 630 and 640 that are associated with different denominations of donation indications. Specifically, row 630 is associated with a five-cent donation indication and row 640 is associated with a ten-cent donation indication. Thus, the text field 632 indicates a quantity of days that the $10 donation will last if 5 five-cent donation indications are transmitted each day. Likewise, the text field 642 indicates a quantity of days that a $10 donation will last if 5 ten-cent donation indications are transmitted each day. The estimated annual donation fields 634 and 644 indicate the estimated annual donation that would be required in order to use 5 five-cent and ten-cent, respectively, donation indications per day. As shown in FIG. 6, the donor should expect to donate about $91.25 per year if the donor uses 5 ten-cent donation indications each day.

In other embodiments, the user interface 600 may comprise additional denominations and/or may allow the donor to select a custom denomination, such as three-cents, for example. Additionally, in other embodiments the user interface 600 allows the donor to select any donation amount, rather than the indicated $10 donation amount in exemplary user interface 600. In other embodiments, non-monetary donations may be given to donees, and the donation calculator may be configured to calculate donation amounts for one or more types of donations, including monetary and non-monetary goods, such as, for example, money, airline miles, cell phone minutes, services, or tangible goods.

### VIII. Donation Toolbar

FIGS. 7 and 8 illustrate one embodiment of toolbars 700 associated with an email program, including a donation toolbar 710 for insertion and tracking of donation indications. In the embodiment of FIGS. 7 and 8, Microsoft® Outlook is the email program comprising toolbars 700. As shown, the donation toolbar 710 comprises two buttons 702, 704. In the embodiment of FIG. 7, a contribution amount pane 706 is displayed to the donor. The contribution amount pane 706 indicates a total amount contributed by the donor. In the exemplary illustration of FIG. 7, the donor has donated a total of $10, as illustrated in the contribution amount pane 706. In other embodiments, the contribution amount button 704 indicates total contributions to each of multiple donees, rather than, or in addition to, display of a total donation amount to all donees. In one embodiment, the contribution amount pane 706 is displayed in response to hovering a pointer, such as a mouse pointer, over the contribution amount button 704. In one embodiment, the contribution amount button 704 may be selected in order to display additional information regarding the donors account. For example, in one embodiment the contribution amount button 704 may be selected by clicking on the contribution amount button 704. In response to selection of the contribution amount button 704, a user interface of the donation website 166 may be displayed in a web browser or in a portion of the email program. In one embodiment, when the contribution amount button 704 is selected, the donor is presented with a user interface that allows the donor to make a donation, such as described with respect to FIG. 3.

In the embodiment of FIG. 8, a donation indication status pane 703 is displayed to the donor. In the embodiment of FIG. 8, the donation indications status pane 703 indicates a quantity of donation indications transmitted in electronic indications since the email program was executed, a total number of donation indications transmitted in emails for all sessions, and a remaining quantity of donation indications that may be included in emails, or other electronic communications. In other embodiments, the donation indication status pane 703 may include additional information regarding the donor's account and the used and/or available donation indications. In one embodiment, the donation indications status pane 703 is displayed in response to hovering a pointer, such as a mouse pointer, over the donation indication button 702. In one embodiment, the donation indication button 702 may be selected, such as by clicking on the donation indication button 702, in order to open a user interface including additional information regarding the donor's account in a web browser, for example. In one embodiment, selection of the donation indication button 702 opens a user interface of the donation website 166.

### IX. Email Interface

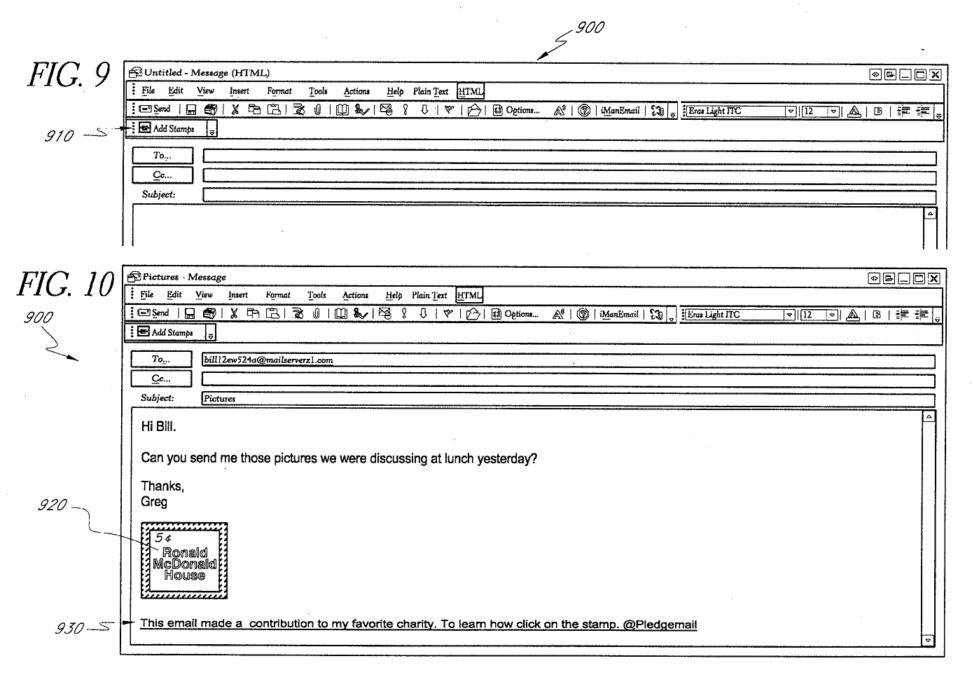

FIG. 9 illustrates one embodiment of an email composition interface 900, the interface 900 comprising a donation indication insertion button 910. In the embodiment of FIG. 9, the donation indication insertion button 910 is specifically configured to insert donation indications that are graphical images of postage stamps into the body of an email. In other embodiments, the donation indication insertion button 910 may be labeled differently and the donation indications may be textual, visual, audible, or any combination of graphic, visual, textual, and audible. In this embodiment, when the donation indication insertion button 910 is selected, such as by clicking on the donation indication insertion button 910, a donation indication, such as a graphical image of a postage stamp, is inserted into the body of the email.

FIG. 10 illustrates the email composition interface 900 of FIG. 9, wherein an email has been composed and a donation indication 920 has been inserted into the email. As noted above with respect to FIG. 9, the donation indication insertion button 910 is configured to insert a graphical image of a postage stamp into emails. Thus, as illustrated in FIG. 10, the donation indication 920 comprises a graphical image of a postage stamp. In this embodiment, the donation indication 920 comprises an indication of the donee to which a donation has already been made by the donor, as well as an indicator of a donation denomination associated with the donation indication 920. In one embodiment, the donation indication 920 is associated with a link to a website associated with the donee. As illustrated in exemplary FIG. 10, the donee associated with the donation indication 920 is the Ronald McDonald House. In one embodiment, if the recipient of the email comprising the donation indication 920 selects the donation indication 920, a website associated with the Ronald McDonald House may be opened in a browser installed on the recipient computing device. In one embodiment, insertion of a donation indication also inserts a donation explanation 930 that indicates that the donation indication 920 is associated with an actual donation made by the donor to the donee. In one embodiment, the donation explanation 930 is linked to the donation website 166 such that the recipient may view the content of the donation website 166 in response to selecting the donation explanation 930. In another embodiment, the donation indication 920 may be linked to the donation website 166.

### X. Other Embodiments

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

It is also recognized that the term “remote” may include data, objects, devices, components, and/or modules not stored locally, that are or are not accessible via the local bus. Thus, remote data may include a device which is physically stored in the same room and connected to the network. In other situations, a remote device may also be located in a separate geographic area, such as, for example, in a different location, country, and so forth.

What is claimed is:

1. A computerized system for transferring a donation from a donor to a donee, the computerized system comprising:
an input module for receiving respective donations from one or more donors;
a donee management module configured to determine when a donation payment should be sent to the donee; and
a verification module configured to generate a verification code associated with the donation payment, the verification code being usable by the donee to access information regarding the one or more donors.

2. The computerized system of claim 1, wherein the donee management module is further configured to determine a donation balance to the donee, the donation balance comprising a sum of the donations from the one or more donors since a last donation payment was made to the donee.

3. The computerized system of claim 2, wherein the determination as to when a donation payment should be sent to the donee is based at least partly on the determined donation balance.

4. The computerized system of claim 1, wherein the determination as to when the donation payment should be sent to the donee is based at least partly on a time period since a previous donation payment was made to the donee.

5. The computerized system of claim 2, wherein a donation payment is sent to the donee when the donation balance is greater than or equal to a predetermined donation threshold and a time period since a previous donation payment was made to the donee is greater than or equal to a predetermined payment period.

6. The computerized system of claim 5, wherein the donation threshold is selected from the group comprising: $5, $10, $15, $20, $25, $50, $100, $200, $250, $300, $500, and $1,000.

7. The computerized system of claim 5, wherein the payment period is selected from the group comprising: 7 days, 10 days, 30 days, one month, 60 days, two months, three months, and six months.

8. The computerized system of claim 1, wherein the donation payment is sent via at least one of a check, money order, cash, credit card, electronic funds transfer, PayPal, and Google CheckOut payment.

9. The computerized system of claim 1, further comprising:
a user interface for accepting input of the verification code and, in response to receiving the verification code, providing information regarding the one or more donors via the user interface.

10. The computerized system of claim 9, wherein the user interface is configured for viewing in a web browser.

11. The computerized system of claim 1, wherein the information regarding the one or more donors comprises at least one of an email address, a residential address, a telephone number, a donation amount, and information regarding a number of donation indications associated with the donee that have been included in electronic communications by each of the one or more donors.

12. The computerized system of claim 11, wherein the information regarding the one or more donors includes more information if the donee is a registered donee than if the donee is a non-registered donee.

13. The computerized system of claim 1, wherein the donation payment comprises a business check that is sent to the donee, the verification code being included with the business check.

14. A method of transferring a donation amount to a donee, the method comprising:
receiving a donation amount from one or more donors for a donee;
determining a donation balance due to the donee since a last donation payment was made to the donee;
determining, based at least partly on the donation balance, when a donation payment should be sent to the donee; and
generating a verification code associated with the donation payment, the verification code being usable by the donee to access information regarding the one or more donors.

15. The method of claim 14, further comprising:
transmitting a donation payment to the donee when the donation balance is greater than or equal to a predetermined donation threshold and a time period since a previous donation payment was made to the donee is greater than or equal to a predetermined payment period.

16. The method of claim 15, wherein the donation threshold is selected from the group comprising: $5, $10, $15, $20, $25, $50, $100, $200, $250, $300, $500, and $1,000.

17. The method of claim 15, wherein the payment period is selected from the group comprising: 7 days, 10 days, 30 days, one month, 60 days, two months, three months, and six months.

18. The method of claim 15, wherein the donation payment is transmitted via at least one of a check, money order, cash, credit card, electronic funds transfer, PayPal, and Google CheckOut payment.

19. The method of claim 14, further comprising:
providing information to the donee regarding the one or more donors in response to receiving the verification code.

20. A storage medium including a computer program stored thereon for performing the method of:
receiving a donation amount from one or more donors for a donee;
determining a donation balance due to the donee since a last donation payment was made to the donee;
determining, based at least partly on the donation balance, when a donation payment should be sent to the donee; and
generating a verification code associated with the donation payment, the verification code being usable by the donee to access information regarding the one or more donors.
